(19) United States
(12) Patent Application Publication
(10) Pub. No.: US 2010/0310926 A1
(43) Pub. Date: Dec. 9, 2010

(54) BATTERY CELL OF A CYLINDRICAL LITHIUM ION BATTERY

(75) Inventors: Yue-li WANG, Dongguan city (CN); Kai WU, Dongguan city (CN); Yun-fei XU, Dongguan city (CN); Wei CHEN, Dongguan city (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignees: Dongguan Amperex Technology Limited; Dongguan Amperex Electronics Technology Limited

(21) Appl. No.: 12/790,248

(22) Filed: May 28, 2010

(30) Foreign Application Priority Data
Jun. 3, 2009 (CN) 200920057788.4

(51) Int. Cl. H01M 6/08

(52) U.S. Cl. 429/164

(57) ABSTRACT

A battery cell of a cylindrical lithium ion battery includes an anode plate and a cathode plate wounded together with an insulating separator disposed between the anode plate and the cathode plate. The anode plate includes an anode current collector and an anode film formed on the anode current collector. The anode current collector is formed with an anode exposed portion without the anode film formed thereon. The anode exposed portion is soldered with a number of anode terminals. The cathode plate includes a cathode current collector and a cathode film formed on the cathode current collector. The cathode current collector is provided with a cathode exposed portion without the cathode film formed thereon. The cathode exposed portion is soldered with a number of cathode terminals. The anode terminals and the cathode terminals are disposed at two opposite sides of the battery cell.

### CROSS-REFERENCE TO RELATED APPLICATION

The present patent application claims the benefit of Chinese Patent Application No. 200920057788.4, filed Jun. 3, 2009, the disclosure of which is hereby incorporated herein by reference in its entirety.

### FIELD OF THE INVENTION

The present patent application generally relates to lithium ion batteries and, more particularly, to a battery cell of a cylindrical lithium ion battery.

### BACKGROUND OF THE INVENTION

With rapid development of modern science and technology, portable electric devices, such as cameras, laptop computers, MP4, portable DVDs and digital cameras are becoming increasingly popular in people's daily life.

Lithium ion batteries, especially cylindrical lithium ion batteries, have been widely used in various portable electric devices due to high energy density, high working voltage and long life span. At present, lithium ion batteries have also been a desirable power source in vehicles and medical devices.

Typically, a battery cell of a cylindrical lithium ion battery includes an anode plate and a cathode plate wounded together with an insulating separator disposed between the anode plate and the cathode plate. The anode plate includes an anode current collector and an anode film containing anode active material formed on the anode current collector. The cathode plate includes a cathode current collector and a cathode film having cathode active material disposed on the cathode current collector. The insulating separator is a porous film obtained via plasticization and extraction, which can maintain the organic electrolytic containing lithium salts.

However, conventional battery cell of a cylindrical lithium ion battery only includes a single anode terminal and a single cathode terminal. Therefore, the charge and discharge current cannot meet actual requirement of the portable electric devices, and the rate capability of the cylindrical lithium ion battery is not desirable.

What is needed, therefore, is to provide a battery cell for use in a cylindrical lithium ion battery, which can be charged and discharged at a high rate.

### SUMMARY OF THE INVENTION

One object of the present invention is to provide a battery cell of a lithium ion battery which can be charged and discharged at a high rate.

According to one embodiment of the present invention, a battery cell of a cylindrical lithium ion includes an anode plate and a cathode plate wounded together with an insulating separator disposed between the anode plate and the cathode plate. The anode plate includes an anode current collector and an anode film formed on the anode current collector. The anode current collector is formed with an anode exposed portion without the anode film formed thereon. The anode exposed portion is soldered with a number of anode terminals. The cathode plate includes a cathode current collector and a cathode film disposed on the cathode current collector. The cathode current collector is provided with a cathode exposed portion without the cathode film disposed thereon. The cathode exposed portion is soldered with a number of cathode terminals. The cathode terminals and the anode terminals are located at two opposite sides of the battery cell.

According to the embodiment of the present invention, the battery cell of the cylindrical lithium ion battery forms a number of anode terminals and cathode terminals, which enables the cylindrical lithium ion battery to charge and discharge at high rate.

Preferably, the anode exposed portion is continuously formed on the anode current collector, the cathode exposed portion is continuously formed on the cathode current collector.

Preferably, the anode terminals are bent and soldered together to form an anode lead, the cathode terminals are bent and soldered together to form a cathode lead, and the cathode lead and the anode lead are situated at two opposite sides of the battery cell.

Preferably, the cathode terminal is formed in a strip shape or in a T shape.

Preferably, the cathode terminals soldered on the cathode exposed portion are arranged at an equal interval of distance.

Preferably, the anode terminal is formed in a strip shape or in a T shape.

Preferably, the anode terminals soldered on the anode exposed portion are arranged at an equal interval of distance.

Other advantages and novel features will be drawn from the following detailed description of preferred embodiments with the attached drawings. The accompanying drawings, which are incorporated in and constitute a part of this specification, illustrate embodiments of the present invention and, together with a general description of the invention given above, and the detailed description of the embodiments given below, serve to explain the principles of the invention.

### BRIEF DESCRIPTION OF THE DRAWINGS

FIG. 1 depicts a top view of an unwound anode plate for use in a battery cell of a cylindrical lithium ion battery in accordance with a first embodiment of the present invention;

FIG. 2 depicts a top view of an unwound anode plate for use in a battery cell of a cylindrical lithium ion battery in accordance with a second embodiment of the present invention;

FIG. 3 depicts a top view of an unwound cathode plate of a battery cell for use in a cylindrical lithium ion battery in accordance with a first embodiment of the present invention;

FIG. 4 depicts a top view of an unwound cathode plate for use in a battery cell of a cylindrical lithium ion battery in accordance with a second embodiment of the present invention;

FIG. 5 depicts a top view of a laminate structure of the anode plate as shown in FIG. 2 and the cathode plate as shown in FIG. 4;

FIG. 6 depicts a cross sectional view of the laminate structure along a line V-V as shown in FIG. 5;

FIG. 7 depicts a perspective view of a battery cell of a cylindrical lithium ion battery according to one embodiment of the present invention;

FIG. 8 depicts a right side view of the battery cell as shown in FIGS. 7; and

FIG. 9 depicts a left side view of the battery cell as shown in FIG. 7.

### DETAILED DESCRIPTION OF THE INVENTION

Referring to FIG. 1 and FIG. 2, an anode plate 20 for use in a battery cell of a cylindrical lithium ion battery according to one embodiment of the present invention includes an anode current collector 22 made from copper foil and an anode film 24 containing anode active material formed on the anode current collector 22. One long side of the anode current collector 22, i.e. the upper side of the anode current collector 22 as illustrated in FIG. 1 forms a continuous anode exposed portion 220 without anode film 24 formed thereon. A number of anode terminals are soldered on the anode exposed portion 220 at an equal interval of distance. Each of the anode terminals can be a strip-shaped anode terminal 25a as shown in FIG. 1, or a T-shaped anode terminal 25b as shown in FIG. 2, or other anode terminals having other shapes as known in the art.

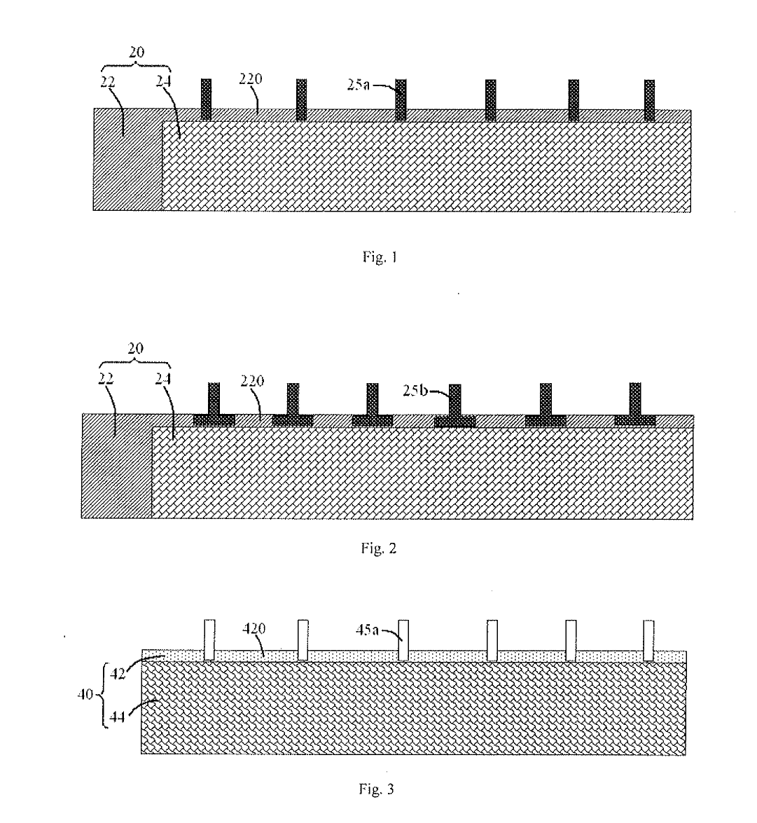

Referring to FIG. 3 and FIG. 4, a cathode plate 40 for use in the battery cell of a cylindrical lithium ion battery includes a cathode current collector 42 of aluminum foil and a cathode film 44 with cathode active material formed thereon. The cathode current collector 42 forms a continuous cathode exposed portion 420 without cathode film 44 formed thereon at a long side thereof, i.e. the upper side of the cathode current collector 42 as illustrated in FIG. 3. The cathode exposed portion 420 is soldered with a number of cathode terminals spaced along the cathode exposed portion 420 at an equal interval of distance. The cathode terminal can a strip-shaped cathode terminal 45a as shown in FIG. 3, or a T-shaped cathode terminal 45b as shown in FIG. 4, or cathode terminal having other shapes known in the art.

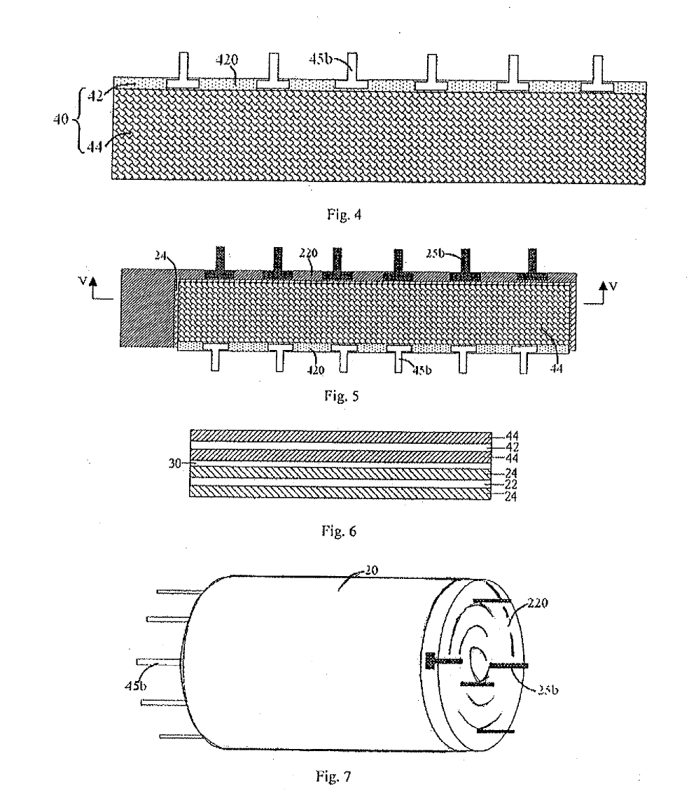

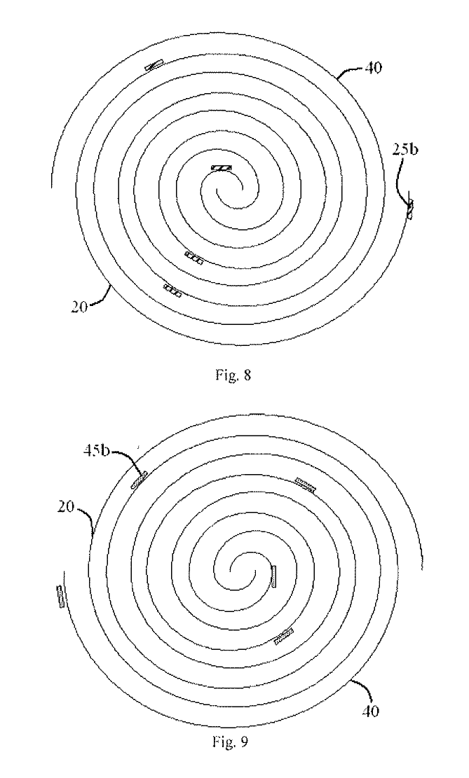

Referring to FIG. 5 to FIG. 9, during manufacturing of the cylindrical lithium ion battery, the anode plate 20 as shown in FIG. 1 or Pig. 2 and the cathode plate 40 as shown in FIG. 3 or FIG. 4 are stacked and spirally wounded together with an insulating separator 30 disposed between the anode plate 20 and the cathode plate 40, to form a battery cell. In the embodiment of the present invention as shown in FIG. 7, the anode terminals 25a, 25b and the cathode terminals 45a, 45b are arranged at two opposite sides of the battery cell, i.e. the right side of the battery cell and the left side of the battery cell. The anode terminals 25a, 25b at right side of the battery cell are bent and soldered together to form an anode terminal lead (not shown). The cathode terminals 45a, 45b at left side of the battery cell are bent and soldered together to form a cathode terminal lead (not shown). The battery cell is accommodated in a can made from steel, aluminum or other appropriate materials. The electrolyte is filled in the can. After vacuum and sealing, the cylindrical lithium ion battery is obtained.

It should be noticed that, in the battery cell of a cylindrical lithium ion battery according to the embodiments of the present invention, thickness and number of the anode terminals 25a, 25b on the anode plate 20, thickness and number of the cathode terminals 45a, 45h on the cathode plate 40 can be adjusted according to the requirement of the charge and discharge rate. Additionally, the anode terminals 25a, 25b are located out of the anode film 24. The cathode terminals 45a, 45b are located out of the cathode film 24. The arrangement of the anode terminals 25a, 25b and the cathode terminals 45a, 45b will not adversely affect smoothness of the interface between the anode plate 20 and the cathode plate 40. The arrangement of the anode terminals 25a, 25b and the cathode terminals 45a, 45b not only can improve the charge and discharge performance of the cylindrical lithium ion battery, but can improve the circle performance of the cylindrical lithium ion battery.

While the present invention has been illustrated by the above description of the preferred embodiments thereof, while the preferred embodiments have been described in considerable detail, it is not intended to restrict or in any way limit the scope of the appended claims to such details. Additional advantages and modifications within the spirit and scope of the present invention will readily appear to those ordinary skilled in the art. Consequently, the present invention is not limited to the specific details and the illustrative examples as shown and described.

What is claimed is:

1. A battery cell of a cylindrical lithium ion battery, comprising:
an anode plate and a cathode plate wounded together with an insulating separator disposed between the anode plate and the cathode plate;
the anode plate comprising an anode current collector and an anode film formed on the anode current collector, the anode current collector being provided with an anode exposed portion without the anode film formed thereon, the anode exposed portion being soldered with a plurality of anode terminals;
the cathode plate comprising a cathode current collector and a cathode film formed on the cathode current collector, the cathode current collector being provided with a cathode exposed portion without the cathode film formed thereon, the cathode exposed portion being soldered with a plurality of cathode terminals; and
the anode terminals and the cathode terminals being located at two opposite sides of the battery cell.

2. The battery cell of claim 1, wherein the anode exposed portion is continuously formed on the anode current collector, the cathode exposed portion is continuously formed on the cathode current collector,

3. The battery cell of claim 1, wherein the anode terminals are bent and soldered together to form an anode lead, the cathode terminals are bent and soldered together to form a cathode lead, and the cathode lead and the anode lead are situated at two opposite sides of the battery cell.

4. The battery cell of claim 1, wherein the cathode terminal is formed in a strip shape or in a T shape.

5. The battery cell of claim 1, wherein the cathode terminals soldered on the cathode exposed portion are arranged at an equal interval of distance.

6. The battery cell of claim 1, wherein the anode terminal is formed in a strip shape or in a T shape.

7. The battery cell of claim 1, wherein the anode terminals soldered on the anode exposed portion are arranged at an equal interval of distance.
